(19) United States
(12) Patent Application Publication
(10) Pub. No.: US 2014/0067896 A1
(43) Pub. Date: Mar. 6, 2014

(54) Universe has an End

(71) Applicant: Iryna Borisovna Shevchenko, Stockton, CA (US)

(72) Inventor: Iryna Borisovna Shevchenko, Stockton, CA (US)

(73) Assignee: Iryna Borisovna Shevchenko, Stockton, CA (US)

(21) Appl. No.: 13/555,179

(22) Filed: Sep. 4, 2012

(51) Int. Cl. G06F 17/11

(52) U.S. Cl. CPC G06F 17/11
USPC 708/620

(57) ABSTRACT

The “Big Bung!” was not at the beginning of Universe!

The number 0 has the value of ∞ (infinity). There we have presented my theory about the number “0” and conclusions of that theory.

To be the very simple, the science of mathematics was originated for the count of of objects and the later on for the measurement of size and qualitiy of objects using the logical means. The science of physics was originated as the science of measurement of motion of objects and different physical properties.

The laws of mathematics are based on the study of absolute values, assuming that the size is permanent quality of object; the laws of math are using the abstract logical means and therefore they are permanent and constant. The laws of physics are based on the study of relative values (opposite to logical) because the properties of objects do depend from the environment they are in and they could change.

The science of mathematics was originated at ancient times when there were no science of physics was known yet. But the people tried to understand and study the physical laws as well, anyway; as there was no separate subject of physics, some of the physical properties of objects (which could be the the relative or opposite to absolute and permanent values) were applied to math.

To start, let's define the what logic is and what logical values mean: the logic is the abstract thinking and the logical values do not have the absolute values; “yes” and “no” are logical values. Those values: “yes” and “no” are currently represented in the mathematics by the numbers “0” and “1” or “object exists” and “object does not exists”. That is the mistaken concept because the both symbols at comparison should belong to the same category of values: you could not compare the cow with milk, for example. The both values in comparison should be either the logical either the absolute values. The number “1” here assumingly should represent the absolute value, so should the number “0”. But in the reality the number “0” at this comparison is the logical value because the everything in material world we know have some properties and there is no such thing as “nothing”: even the pure vacuum in the space has the property of volume (size) it takes.

There is the law of constancy (balance): where the all objects that exist in environment are subjects to the order. The any material object may not physically dissapear without leaving some trace or residue and the space.

The empty space without the objects are included in that law because there is no material object could be born, grow or die without the space taking part in that process, so it is the physical object with undefined qualities. For example, the current technologies do not allow to us to detect the anything material present in the vacuum, which doesn't mean that the vacuum is not the physical substance, it may have some properties that we did not learned yet. The main thing that the even vacuum has the physical property: its volume (size), and it might be theoretically measured.

The all objects have the life span when they die, leaving the space with undefined or undetected matter after them; there is also the space reserved for the objects that have never existed or would not exist. The one of main subject of science of mathematics is the volume(s) of object.

The math could study the volume (size) of any “matter”, doesn't matter if that “matter” might be physically defined or detected or it could be not, it could study the size that takes the empty space.

The currently number “0” represents the value of “nothing”. But the “nothing” it is just the logical abstract value; it is not the absolute value. Therefore the number “0” might not stand in the Row of numbers that symbolically represents the absolute values, as it would be mathematicaly incorrect, as we could write the mathematical expressions only using the absolute values. The only the absolute values are symbolically represented by the number(s). The mathematical operands: which is the abstract or values should not be listed and presented at the Row of numbers.

The the empty space is the space that was left after the object have expired or its space was replaced by it, we call in number “0” —which means “no object present”. The space that is currently taken by material object has the define volume (size), the space that was left after the object exprired has some size as well. But we may not measure the size of the empty space as we might not detect the physical object that may be defined by applying to it the logical means for measuring.

So, at the least we could say that the value of number “0” is undefined, because that is the absolute number, as we proved above (not the logical abstract value). But, with the some presumption, we may say that the volume of the object that never existed is equal to volume of object that would never exist—that for the order to the anything material to exist the space is required; it means that the number “0” is constant value, it never changes because it does not have physical properties and it would exist longer than any imaginable material object because the without the space it would not able to come to existence.

So, the symbolical value of number “0” could be presented with symbol “∞” (infinity). The symbolic number “∞” could not be applied to any material object (Universe, for example), as the any material object have the life span always; the object without the life span (time of existence) is the empty space or “∞”. So, instead of number “∞” at the end of Row of numbers, we would have to put the smallest known number “epsilon” because the value of time is greater at the beginning of object existence and came to end when the object dies.

So, as the result, we have the mathematical Row of numbers: epsilon, . . . 4, 3, 2, 1, ∞

The conclusions:

1. At the any math expression there is the object that is being operated on and the mathematical operand. The mathematical operand is the logical value “yes” or “no” or the count of that. We know that the mathematical expression should be equal on the opposite sides. That should be related to the volume(s) of the material objects that are present at expression only and not to the symbolical values that are used as the mathematical operands. Therefore, to multiply or divide by fraction of “yes” or “no” is the logical nonsense (such as 0.3 of “yes” or 0.1 of “no”).

The proof:

Take 1 paper dollar bill and multiply that by 0.5=0.5 dollar bill. That is the wrong mathematical expression: the part of the paper dollar bill on the left side of expression became “virtual” (dissapeared) as the result of that mathematical operation. For the comparison, take the 1 paper dollar bill and divide that by 2=0.5 dollar bill; that is the correct mathematical expression. The result of that mathematical operation assumes that there are the TWO halves of bill as the result of that mathematical operation

2. The mathematical operation division by “0” (which is “cc”) is allowed, because “0” represents the absolute object, not logical value.

The proof:

Please, divide the number “5” by number “0”. The number “5” is the mathematical operand here and the number “0” is operated object. The resulf of that mathematical expression would be “undefined” which is the value of number “0”. The mathematical value of number “0” is “cc” which, we may say, is undefined constant. As the additional proof, try to multiply the number “5” by number “0”. The result of that mathematical expression would be “0” and this is correct mathematical expression because the number “0” is the absolute number and has the value of “constant” (“∞”) here and the number “5” is just the mathematical operand. There could be the nothing more than infinity; we do not know the bigger value; so by the multiplying the number “5” to the greatest value known, we may get the only that value (greatest value that is known to us: infinity). As we did not tried to operate by number “0” (“∞”), as in previous example, we did not get as the result of this expression the value of number “0” (which is “undefined” or infinity). At the last example we did tried only multiply that object, so the result is saying to us that this is the greatest object and it may not became greater.

3. The universal measurement unit “0” and “1” is logically incorrect.

The universal measurement unit can not be defined as Dual (value and no value), but should be defined as Singular (value and constant). The more detailed description about that matter was provided above.

### Proof:

The number “1” here represents the object (material value) and number “0” here represents the only logical operand (not the object),. We know that the any object does not dissapear without leaving the after itself space, which has the value in math: volume. So, the “1” and “∞” (value and constant) are allowed measurement units

1. (canceled)

2. The mathematical operation the division by number “0” is allowed.

3. The Universal measure structure in not Dual (“value” and “no value”), but Singular (“value” or “constant”).

4. The mathematical operations of multiplication and division by the fractions is not allowed.
